(19) United States
(12) Patent Application Publication
(10) Pub. No.: US 2019/0163756 A1
(43) Pub. Date: May 30, 2019

(54) HIERARCHICAL QUESTION ANSWERING SYSTEM

(71) Applicant: INTERNATIONAL BUSINESS MACHINES CORPORATION, ARMONK, NY (US)

(72) Inventors: Brendan Bull, Durham, NC (US); Scott R. Carrier, Apex, NC (US); Aysu Ezen Can, Cary, NC (US); Dwi Sianto Mansjur, Cary, NC (US)

(21) Appl. No.: 15/825,610

(22) Filed: Nov. 29, 2017

(51) Int. Cl. G06F 17/30; G06N 5/02

(52) U.S. Cl. CPC G06F 17/3053; G06F 17/30395; G06N 5/02; G06F 17/30451; G06F 17/30598; G06F 17/30554

(57) ABSTRACT

A method for providing a hierarchical question answering system for presenting structured answers to a query is provided. The method may include receiving a query for a question answering system. The method may further include generating first queries based on the query. The method may further include generating second queries based on the first queries. The method may further include clustering the query, the first queries, and the second queries to form a hierarchy of queries. The method may also include processing the hierarchy of queries to generate answers. The method may further include clustering the answers to form a hierarchy of answers. The method may also include ranking the hierarchy of answers. The method may also include aggregating the hierarchy of answers to generate an optimal answer. The method may further include presenting the hierarchy of queries, the hierarchy of answers, and the optimal answer.

### BACKGROUND

The present invention relates generally to the field of computing, and more specifically, to data processing and management.

Generally, question answering systems may include systems that automatically answer questions that are posed to the question answering system through information retrieval and natural language processing techniques. Typically, the question answering system may construct answers by querying a structured database of knowledge or information, usually called a knowledge base, or by pulling answers from an unstructured collection of natural language documents. Most current question answering systems focus on factoid questions. Factoid questions are questions that can be answered with simple facts expressed in short text answers. More specifically, the question answering system may receive a natural language question as input, transform the received natural language question from the input into a query, and extract information from the query to find answers that satisfies the query from different corpuses.

### SUMMARY

A method for providing a hierarchical question answering system for presenting structured answers to a query is provided. The method may include receiving at least one query for a question answering system. The method may further include generating a first set of queries based on the received at least one query. The method may further include generating a second set of queries based on the generated first set of queries. The method may further include clustering the received at least one query, the generated first set of queries, and the generated second set of queries to form a hierarchy of queries. The method may also include processing the hierarchy of queries via the question answering system to generate a plurality of answers associated with the hierarchy of queries. The method may further include clustering the generated plurality of answers to form a hierarchy of answers that match the hierarchy of queries. The method may also include ranking the hierarchy of answers associated with the hierarchy of queries for the received at least one query. The method may also include aggregating one or more answers from the hierarchy of answers to generate an optimal answer to the received at least one query. The method may further include presenting the hierarchy of queries, the hierarchy of answers, and the optimal answer to a user.

A computer system for providing a hierarchical question answering system for presenting structured answers to a query is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving at least one query for a question answering system. The method may further include generating a first set of queries based on the received at least one query. The method may further include generating a second set of queries based on the generated first set of queries. The method may further include clustering the received at least one query, the generated first set of queries, and the generated second set of queries to form a hierarchy of queries. The method may also include processing the hierarchy of queries via the question answering system to generate a plurality of answers associated with the hierarchy of queries. The method may further include clustering the generated plurality of answers to form a hierarchy of answers that match the hierarchy of queries. The method may also include ranking the hierarchy of answers associated with the hierarchy of queries for the received at least one query. The method may also include aggregating one or more answers from the hierarchy of answers to generate an optimal answer to the received at least one query. The method may further include presenting the hierarchy of queries, the hierarchy of answers, and the optimal answer to a user.

A computer program product for providing a hierarchical question answering system for presenting structured answers to a query is provided. The computer program product may include one or more computer-readable storage devices and program instructions stored on at least one of the one or more tangible storage devices, the program instructions executable by a processor. The computer program product may include program instructions to receive at least one query for a question answering system. The method may further include generating a first set of queries based on the received at least one query. The computer program product may further include program instructions to generate a second set of queries based on the generated first set of queries. The computer program product may also include program instructions to cluster the received at least one query, the generated first set of queries, and the generated second set of queries to form a hierarchy of queries. The computer program product may further include program instructions to process the hierarchy of queries via the question answering system to generate a plurality of answers associated with the hierarchy of queries. The computer program product may also include program instructions to cluster the generated plurality of answers to form a hierarchy of answers that match the hierarchy of queries. The computer program product may further include program instructions to rank the hierarchy of answers associated with the hierarchy of queries for the received at least one query. The computer program product may also include program instructions to aggregate one or more answers from the hierarchy of answers to generate an optimal answer to the received at least one query. The computer program product may further include program instructions to present the hierarchy of queries, the hierarchy of answers, and the optimal answer to a user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2A is a block diagram illustrating a presentation of hierarchical structure that includes generated sets of queries from a received query according to one embodiment;

FIG. 2B is a block diagram illustrating a presentation of hierarchical structures that include generated sets of queries from a received query and answers to the generated sets of queries and the received query according to one embodiment

FIG. 3 is an operational flowchart illustrating the steps carried out by a program for providing a hierarchical question answering system for presenting structured answers to a query according to one embodiment;

FIG. 4 is a block diagram of the system architecture of a program for providing a hierarchical question answering system for presenting structured answers to a query according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to data processing and management. The following described exemplary embodiments provide a system, method and program product for providing a hierarchical question answering system for presenting structured answers to a received query. Specifically, the present embodiment has the capacity to improve the technical field associated with question answering systems and increase the efficiency of question and answering systems by providing a hierarchical question answering system structure that diversifies queries received at the question answering system through paraphrasing, and provides a hierarchical structure for the diversified queries whereby answers to the paraphrased queries may be received, ranked, and aggregated to provide an optimal answer to the received query. The disclosed hierarchical question answering system can serve as a guideline for designing a high-performance question answering system as well as serve as a measurement for developers to gauge the quality of question-answering systems. More specifically, the system, method and program product may provide a hierarchical question answering system by diversifying a received query through paraphrasing techniques to formulate a hierarchy of paraphrased queries, and ranking and aggregating a hierarchy of paraphrased answers to the hierarchy of paraphrased queries to present a structured optimal answer to the received query based on the a hierarchy of paraphrased queries and answers.

As previously described with respect to data processing and management, question answering systems may receive a natural language question as input, transform the received natural language question from the input into a query, and extract information from the query to find answers that satisfies the query from different corpuses. Receiving the input in the form of a natural language question can make a question-answering system more user-friendly, but harder to implement, as there are various question types and the question answering system may have to identify the correct question type in order to give a sensible answer. Assigning a question type to the question can be an important task as most answer extraction processes rely on finding the correct question type and hence the correct answer type. Keyword and phrase extraction may serve as a first step for identifying the input question type, whereby keywords and phrases are extracted from the inputted query. Therefore, the keywords and phrases in a query are important for determining the question type and the eventual answer type. However, for some question answering systems, different keywords or phrases associated with an inputted query may render different answers/results. As such, it may be advantageous, among other things, to provide a system, method and program product for providing a hierarchical question answering system for presenting structured answers to a received query. Specifically, the system, method, and program product may provide a hierarchical question answering system by diversifying a received query through paraphrasing techniques to formulate a hierarchy of paraphrased queries, and ranking and aggregating a hierarchy of paraphrased answers to the hierarchy of paraphrased queries to present a structured optimal answer to the received query based on the a hierarchy of paraphrased queries and the hierarchy of paraphrased answers.

According to at least one implementation of the present embodiment, at least one query associated with a question answering system may be received. Next, a first set of queries may be generated based on the received at least one query. Then, a second set of queries may be generated based on the generated first set of queries. Next, the received at least one query, the generated first set of queries, and the generated second set of queries may be clustered to generate a hierarchy of queries. Then, the hierarchy of queries may be processed via the question answering system to generate a plurality of answers associated with the hierarchy of queries. Next, the ranked plurality of answers may be organized based on the hierarchy of queries to form a hierarchy of answers to the hierarchy of queries. Then, the hierarchy of answers may be ranked by applying a random tree forest statistical model to the hierarchy of answers. Then, one or more answers from the hierarchy of answers may be aggregated to generate an optimal answer to the received at least one query. Thereafter, the hierarchy of questions, the hierarchy of answers, and the optimal answer may be presented to a user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for providing a hierarchical question answering system for presenting structured answers to a received query.

As previously described, and according to at least one implementation, at least one query associated with a question answering system may be received. Next, a first set of queries may be generated based on the received at least one query. Then, a second set of queries may be generated based on the generated first set of queries. Next, the received at least one query, the generated first set of queries, and the generated second set of queries may be clustered to generate a hierarchy of queries. Then, the hierarchy of queries may be processed via the question answering system to generate a plurality of answers associated with the hierarchy of queries. Next, the ranked plurality of answers may be organized based on the hierarchy of queries to form a hierarchy of answers to the hierarchy of queries. Then, the hierarchy of answers may be ranked by applying a random tree forest statistical model to the hierarchy of answers. Then, one or more answers from the hierarchy of answers may be aggregated to generate an optimal answer to the received at least one query. Thereafter, the hierarchy of questions, the hierarchy of answers, and the optimal answer may be presented to a user.

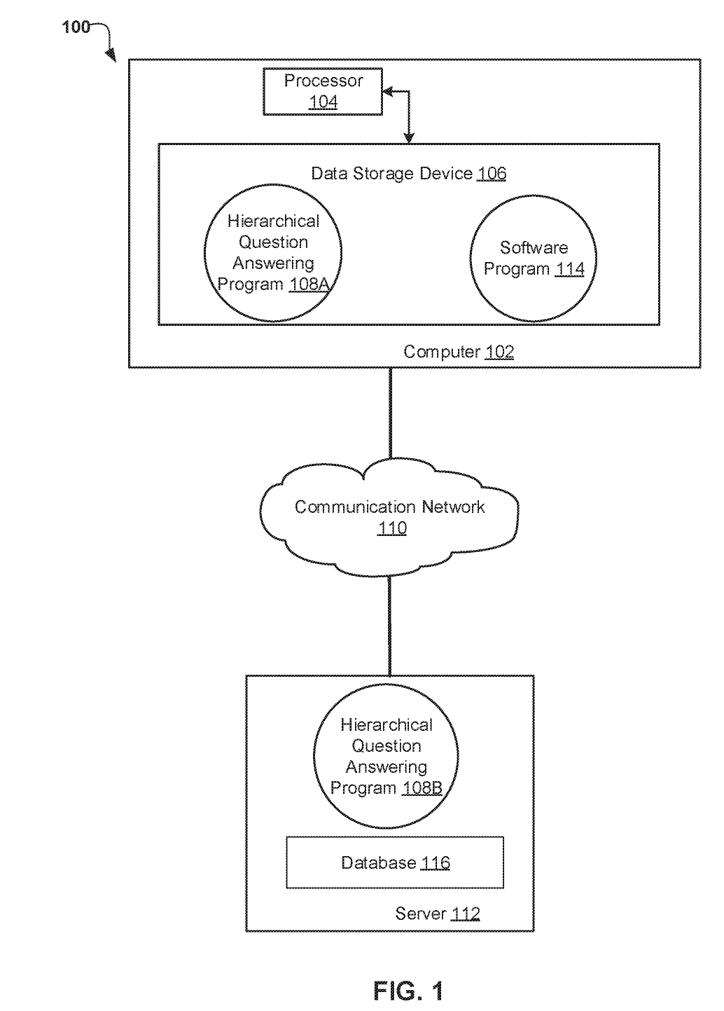

Referring now to FIG. 1, an exemplary networked computer environment 100 in accordance with one embodiment is depicted. The networked computer environment 100 may include a computer 102 with a processor 104 and a data storage device 106 that is enabled to run a hierarchical question answering program 108A and a software program 114, and may also include a microphone (not shown). The software program 114 may be an application program such as an internet browser and a question answering application. The hierarchical question answering program 108A may communicate with the software program 114. The networked computer environment 100 may also include a server 112 that is enabled to run a hierarchical question answering program 108B and the communication network 110. The networked computer environment 100 may include a plurality of computers 102 and servers 112, only one of which is shown for illustrative brevity.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

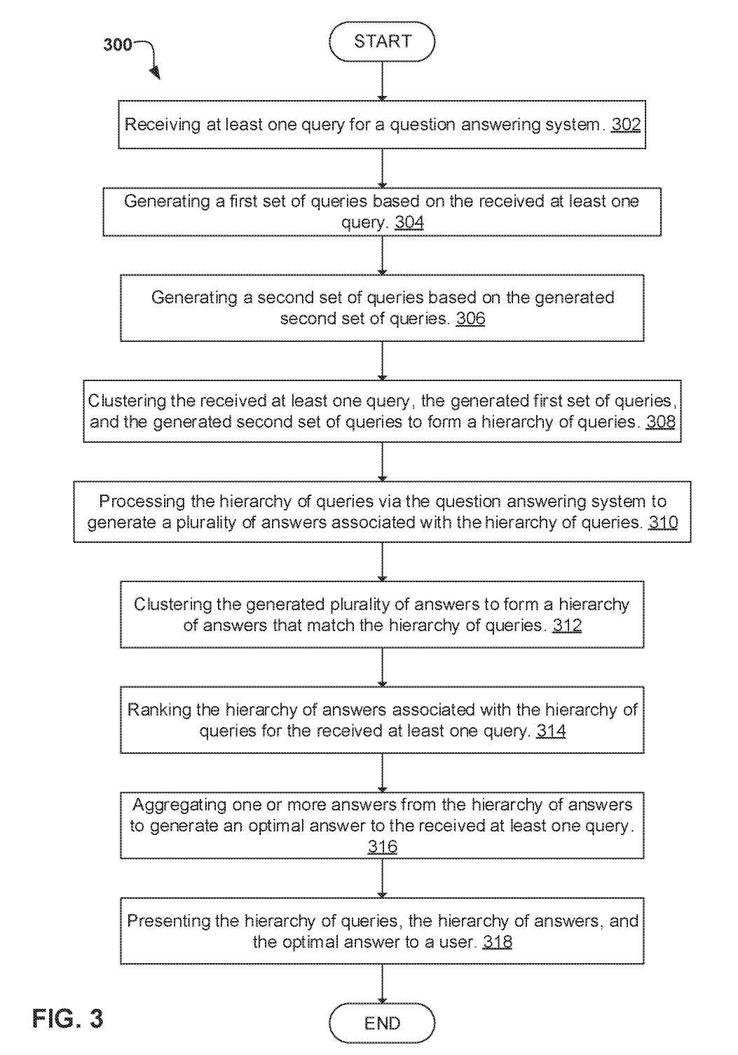

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the hierarchical question answering program 108A, 108B may interact with a database 116 that may be embedded in various storage devices, such as, but not limited to, a mobile device 102, a networked server 112, or a cloud storage service.

According to the present embodiment, a program, such as a hierarchical question answering program 108A and 108B may run on the client computer 102 or on the server computer 112 via a communications network 110. The hierarchical question answering program 108A, 108B may provide a hierarchical question answering system for presenting structured answers to a received query. Specifically, a user using a computer, such as computer 102, may run a hierarchical question answering program 108A, 108B, that may interact with a database 116 and a software program 114, to provide a hierarchical question answering system by diversifying a received query through paraphrasing techniques to formulate a hierarchy of paraphrased queries, and ranking and aggregating a hierarchy of paraphrased answers to the hierarchy of paraphrased queries to present a structured optimal answer to the received query based on the a hierarchy of paraphrased queries and the hierarchy of paraphrased answers.

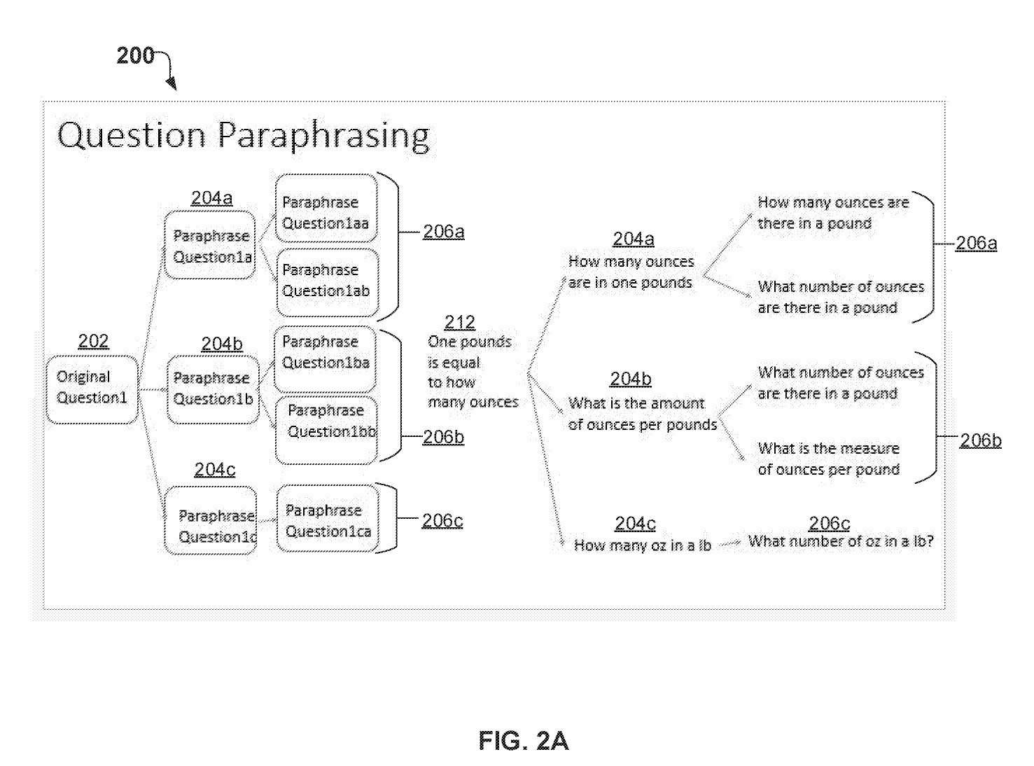

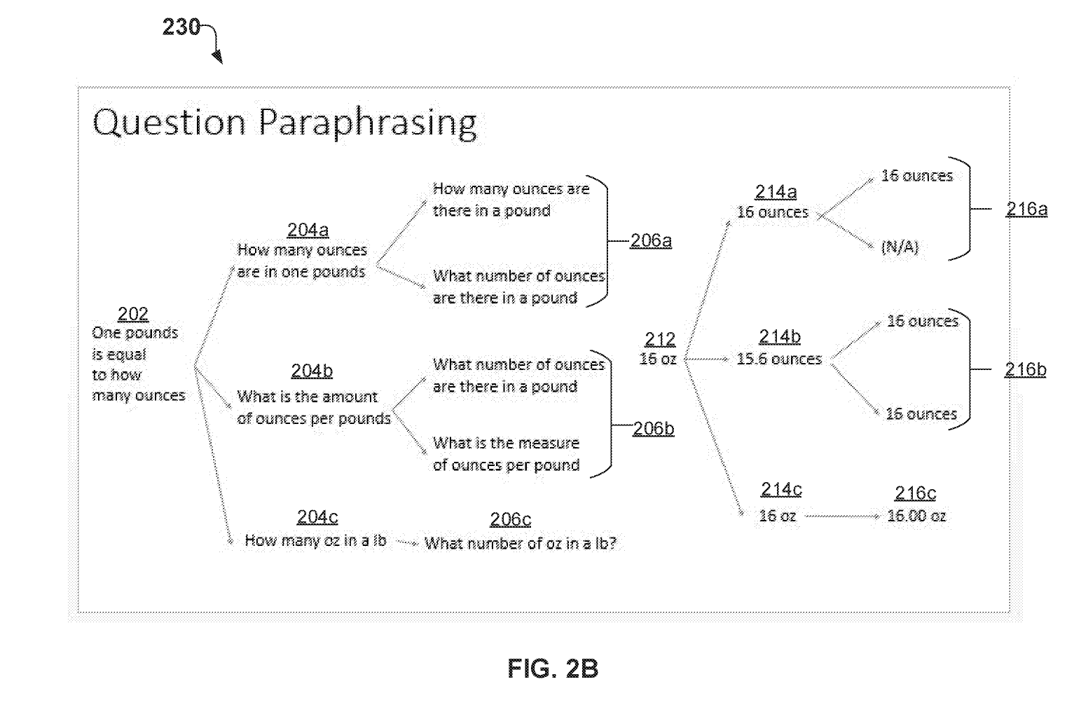

Referring now to FIGS. 2A and 2B, block diagrams 200 and 230 illustrating presentations of hierarchical structures that include generated sets of queries from a received query, and answers to the generated sets of queries and the received query, according to one embodiment are depicted. Specifically, according to one embodiment, the hierarchical question answering program 108A, 108B (FIG. 1) may receive at least one query 202 that includes a question or statement for a question answering system. Thereafter, the hierarchical question answering program 108A, 108B (FIG. 1) may generate a first set of queries 204a, 204b, 204c. Specifically, the hierarchical question answering program 108A, 108B (FIG. 1) may generate the first set of queries 204a, 204b, 204c by syntactically paraphrasing the received at least one query. Then, the hierarchical question answering program 108A, 108B (FIG. 1) may generate a second set of queries 206a, 206b, 206c, whereby the second set of queries may be generated by syntactically paraphrasing the generated first set of queries. Thereafter, the hierarchical question answering program 108A, 108B (FIG. 1) may process the received at least one query 202, the generated first set of queries 204a, 204b, 204c, and the generated second set of queries 206a, 206b, 206c, via the question answering system to generate answers to the received at least one query 202, the generated first set of queries 204a, 204b, 204c, and the generated second set of queries 206a, 206b, 206c. Furthermore, the hierarchical question answering program 108A, 108B (FIG. 1) may rank the generated answers to the received at least one query 202, the generated first set of queries 204a, 204b, 204c, and the generated second set of queries 206a, 206b, 206c. Then, the hierarchical question answering program 108A, 108B (FIG. 1) may determine an optimal answer to the received at least one query 202 by aggregating one or more answers from the ranked answers associated with the generated first set of queries 204a, 204b, 204c and the generated second set of queries 206a, 206b, 206c.

Referring now to FIG. 3, an operational flowchart 300 illustrating the steps carried out by a program for providing a hierarchical question answering system for presenting structured answers to a received query is depicted. At 302, the hierarchical question answering program 108A, 108B (FIG. 1) may receive at least one query 202 for a question answering system. Specifically, and as previously described in FIGS. 2A and 2B, the received at least one query may include a question or statement for processing by the question answering system. For example, the received at least one query 202 may be a question such as, “one pound is equal to how many ounces?”

Next, at 304, the hierarchical question answering program 108A, 108B (FIG. 1) may generate a first set of queries based on the received at least one query. Specifically, and as previously described in FIGS. 2A and 2B, the hierarchical question answering program 108A, 108B (FIG. 1) may generate the first set of queries 204a, 204b, 204c by syntactically paraphrasing the received at least one query. More specifically, by using syntactic paraphrasing/variations, the hierarchical question answering program 108A, 108B (FIG. 1) may generating questions that are connected to the original question associated with the received at least one query rather than using semantic variations that may generate questions that diverge to less connected and attenuated questions to the received at least one query. For example, syntactic variations of a question such as “how do I use productX,” may yield question variations such as, “how to use productX” and “how can I use productX?” However, semantic variations of the original question “how do I use productX” may yield questions such as, “where to buy productX” and/or “how do I use productY,” whereby semantic variations may use knowledge graphs to find out that productY is an alternative to productX.

Therefore, and as previously described in FIGS. 2A and 2B, the hierarchical question answering program 108A, 108B (FIG. 1) may receive at least one query that may include a question such as, “one pounds is equal to how many ounces?” Thereafter, the hierarchical question answering program 108A, 108B (FIG. 1) may syntactically paraphrase the received at least one request by using paraphrasing techniques such as phrase-based statistical machine translations including phrase extraction heuristics to obtain bilingual phrase pairs from word alignments and generate questions of a same syntactic type. As such, in response to receiving the at least one query, “one pounds is equal to how many ounces,” the hierarchical question answering program 108A, 108B (FIG. 1) may generate a first set of queries that may include questions such as, “how many ounces are in one pounds,” “what is the amount of ounces per pounds,” and “how many oz in a lb.”

Then, at 306, the hierarchical question answering program 108A, 108B (FIG. 1) may generate a second set of queries based on the generated first set of queries. Specifically, and as previously described in FIGS. 2A and 2B as well as at step 304, the hierarchical question answering program 108A, 108B (FIG. 1) may generate the second set of queries 206a, 206b, 206c by syntactically paraphrasing the generated first set of queries 204a, 204b, 204c. As such, by using syntactic paraphrasing and generating questions of a same syntactic type, the hierarchical question answering program 108A, 108B (FIG. 1) may improve the connection between the generated paraphrased questions and the received at least one query. For example, and as previously described at step 304, in response to receiving the at least one query, “one pounds is equal to how many ounces,” the hierarchical question answering program 108A, 108B (FIG. 1) may generate a first set of queries 204a, 204b, 204c that may include questions such as, “how many ounces are in one pounds,” “what is the amount of ounces per pounds,” and “how many oz in a pound.” Thereafter, the hierarchical question answering program 108A, 108B (FIG. 1) may generate a second set of queries 206a, 206b, 206c: by syntactically paraphrasing the question “how many ounces are in one pounds” 204a, to generate the questions “how many ounces are there in a pound” 206a and “what number of ounces are there in a pound” 206a; by syntactically paraphrasing the question “what are the amount of ounces per pound” 204b, to generate the questions “what number of ounces are there in a pound” 206b and “what is the measure of ounces per pound” 206b; and by syntactically paraphrasing the question “how many oz in a one lb” 204c, to generate the question “what number of oz in a lb” 206c.

Next, at 308, the hierarchical question answering program 108A, 108B (FIG. 1) may cluster the received at least one query 202, the generated first set of queries 204a, 204b, 204c, and the generated second set of queries 206a, 206b, 206c to form a hierarchy of queries. As previously described at steps 304 and 306, the hierarchical question answering program 108A, 108B (FIG. 1) may generate the first set of queries 204a, 204b, 204c, and the second set of queries 206a, 206b, 206c from a received at least one query 202. Thereafter, the hierarchical question answering program 108A, 108B (FIG. 1) may cluster and organize the received at least one query 202, the generated first set of queries 204a, 204b, 204c, and the generated second set of queries 206a, 206b, 206c into a hierarchy tree to form a hierarchy of queries. Specifically, and as previously described in FIGS. 2A and 2B, the hierarchical question answering program 108A, 108B (FIG. 1) may form the hierarchy to illustrate a hierarchical connection between the received at least one query 202, the generated first set of queries 204a, 204b, 204c, and the generated second set of queries 206a, 206b, 206c. For example, the hierarchical question answering program 108A, 108B (FIG. 1) may illustrate the hierarchical connection by illustrating the received at least one query 202 at the front of the hierarchy, and the generated first set of queries 204a, 204b, 204c at a first level which may have more of a connection to the received at least one query 202 than the generated second set of queries 206a, 206b, 206c that are illustrated at a second level.

Then, at 310, the hierarchical question answering program 108A, 108B (FIG. 1) may process the hierarchy of queries via the question answering system to generate answers 212, 214a, 214b, 214c, 216a, 216b, 216c to the hierarchy of queries. Specifically, the hierarchical question answering program 108A, 108B (FIG. 1) may process the hierarchy of queries by feeding one or more of the queries, associated with the hierarchy of queries into the question answering system to find answers 212, 214a, 214b, 214c, 216a, 216b, 216c to the hierarchy of queries based on search results associated with each query. For example, the hierarchical question answering program 108A, 108B (FIG. 1) may feed the hierarchy of queries that includes the received at least one query 202, the generated first set of queries 204a, 204b, 204c, and the generated second set of queries 206a, 206b, 206c, into the question answering system. Thereafter, the hierarchical question answering program 108A, 108B (FIG. 1) may receive answers 212, 214a, 214b, 214c, 216a, 216b, 216c to one or more of the queries associated with the hierarchy of queries that are generated by the question answering system, and may receive the references associated with the answers 212, 214a, 214b, 214c, 216a, 216b, 216c to the one or more queries.

For example, and according to one embodiment, in response to feeding the query, “how many ounces are in one pound,” at 204a that is associated with the generated first set of queries, and feeding the query, “what is the measure of ounces per pound,” at 206b that is associated with the generated second set of queries, the hierarchical question answering program 108A, 108B (FIG. 1) may receive answers such as “16 ounces” at 214a and 216b, respectively, that may be based on a reference such as a website. Furthermore, according to one embodiment, the hierarchical question answering program 108A, 108B (FIG. 1) may receive the references associated with the answers 214a and 216b. For example, the hierarchical question answering program 108A, 108B (FIG. 1) may receive the answer “16 ounces” at 214a and may receive the reference, such as a website, which may include text such as: “a fluid ounce is a unit that measures volume. A pound is a unit that measures weight. Therefore, the question of how many fluid ounces are in a pound is meaningless until the measured liquid is known. In the example of water and oil, water is denser than oil. Therefore, 16 fluid ounces of water weighs 1.04 while 16 ounces of oil only weighs 0.95 pounds.” Also for example, the hierarchical question answering program 108A, 108B (FIG. 1) may receive the answer “16 ounces” at 216b and may receive the reference, such as a website, which may include text such as: “at room temperature, 16 fluid ounces of water weighs 1.04 pounds.”

Next, at 312, the hierarchical question answering program 108A, 108B (FIG. 1) may cluster the generated answers 212, 214a, 214b, 214c, 216a, 216b, 216c to the hierarchy of queries to generate a hierarchy of answers that match, or mirror, the hierarchy of queries. As previously described at step 308, the hierarchical question answering program 108A, 108B (FIG. 1) may cluster and organize the received at least one query 202, the generated first set of queries 204a, 204b, 204c, and the generated second set of queries 206a, 206b, 206c into a hierarchy to form a hierarchy of queries. Furthermore, the hierarchical question answering program 108A, 108B (FIG. 1) may receive answers 212, 214a, 214b, 214c, 216a, 216b, 216c to the hierarchy of queries. Thereafter, the hierarchical question answering program 108A, 108B (FIG. 1) may cluster and organize the answers 212, 214a, 214b, 214c, 216a, 216b, 216c to the hierarchy of queries into a hierarchy tree to form a hierarchy of answers that matches the hierarchy of queries.

Next, at 314, the hierarchical question answering program 108A, 108B (FIG. 1) may rank the hierarchy of answers 212, 214a, 214b, 214c, 216a, 216b, 216c associated with the hierarchy of queries 202, 204a, 204b, 204c, 206a, 206b, 206c for the received at least one query 202. Specifically, the hierarchical question answering program 108A, 108B (FIG. 1) may rank the hierarchy answers 212, 214a, 214b, 214c, 216a, 216b, 216c to the hierarchy of queries that include the generated first set of queries 204a, 204b, 204c, and the generated second set of queries 206a, 206b, 206c by applying a forest tree statistical model to the hierarchy of answers. More specifically, using the forest tree statistical model, the hierarchical question answering program 108A, 108B (FIG. 1) may apply one or more feature vectors to the generated answers 212, 214a, 214b, 214c, 216a, 216b, 216c and the references associated with the generated answers 212, 214a, 214b, 214c, 216a, 216b, 216c, whereby the one or more feature vectors may analyze an aspect of the answers and the references, such as analyzing the text, determine a confidence score (that may be presented as a percentage, as a number, or as text) for the answers 212, 214a, 214b, 214c, 216a, 216b, 216c, and rank the answers 212, 214a, 214b, 214c, 216a, 216b, 216c based on the confidence score. According to one embodiment, the higher the confidence score associated with the generated answers the more accurate the answers are for the received at least one query (i.e. the original question).

For example, and as previously described at step 310, in response to feeding the hierarchy of queries into the question answering system, the hierarchical question answering program 108A, 108B (FIG. 1) may receive answers such as “16 ounces” at 214a and 216b that may be based on two different references, such as two different uniform resource locators (URLs). The hierarchical question answering program 108A, 108B (FIG. 1) may apply the forest tree statistical model to the hierarchy of answers that includes the answers “16 ounces” at 214a and 216b, as well as the references associated with the hierarchy of answers 212, 214a, 214b, 214c, 216a, 216b, 216c, that may include the websites associated with the answers “16 ounces” at 214a and 216b. Based on the analysis by the forest tree statistical model, the hierarchical question answering program 108A, 108B (FIG. 1) may assign a high confidence score to the answer “16 ounces” at 214a and 216b, but may rank the answer “16 ounces” at 214a higher than the answer “16 ounces” at 216b based on the references.

Then at 316, the hierarchical question answering program 108A, 108B (FIG. 1) may aggregate one or more answers from the hierarchy of answers to generate an optimal answer 212 to the received at least one query 202. Specifically, the hierarchical question answering program 108A, 108B (FIG. 1) may generate an optimal answer 212 to the received at least one query 202 by aggregating one or more answers from the hierarchy of answers based on the ranking assigned to the hierarchy of answers 212, 214a, 214b, 214c, 216a, 216b, 216c at step 314. For example, in response to feeding the hierarchy of queries into the question answering system, the hierarchical question answering program 108A, 108B (FIG. 1) may receive an answer such as “16 ounces” at 214a, 216a, and 216b, may receive an answer such as “15.6 ounces” at 214b, may receive an answer such as “16 oz” at 214c, and may receive an answer such as “16.00 oz” at 216c. Furthermore, based on the analysis by the forest tree statistical model, the hierarchical question answering program 108A, 108B (FIG. 1) may assign high confidence scores to the answers “16 ounces” at 214a, 216a, and 216b, then “16 oz” at 214c, and then “16.00 oz” at 216c, but a lower confidence score to the answer “15.6 ounces” at 214b. As such, the hierarchical question answering program 108A, 108B (FIG. 1) may aggregate the generated answers at 214a, 216a, 216b, 214c, and 216c from the hierarchy of answers to generate an optimal answer of 16 ounces at 212.

Also, according to one embodiment, the hierarchical question answering program 108A, 108B (FIG. 1) may aggregate one or more answers from the hierarchy of answers 212, 214a, 214b, 214c, 216a, 216b, 216c to generate an optimal answer 212 to the received at least one query 202, whereby the optimal answer 212 may include one or more sentences from the one or more answers. For example, in response to feeding the hierarchy of queries into the question answering system, the hierarchical question answering program 108A, 108B (FIG. 1) may receive generated answers 212, 214a, 214b, 214c, 216a, 216b, 216c that may include passages with one or more sentences. For example, the hierarchical question answering program 108A, 108B (FIG. 1) may receive an answer at 214a that may include text such as: “a fluid ounce is a unit that measures volume. A pound is a unit that measures weight. Therefore, the question of how many fluid ounces are in a pound is meaningless until the measured liquid is known. In the example of water and oil, water is denser than oil. Therefore, 16 fluid ounces of water weighs 1.04 while 16 ounces of oil only weighs 0.95 pounds.” Also for example, the hierarchical question answering program 108A, 108B (FIG. 1) may receive an answer at 216b that may include text such as: “at room temperature, 16 fluid ounces of water weighs 1.04 pounds.” Furthermore, the hierarchical question answering program 108A, 108B (FIG. 1) may rank the generated answers 212, 214a, 214b, 214c, 216a, 216b, 216c, and based on the ranking, may determine that the answers at 214a 216b may aggregated and combined to provide the optimal answer 212 to the received at least one query 202.

Then, at 318, the hierarchical question answering program 108A, 108B (FIG. 1) may present the hierarchy of queries 202, 204a, 204b, 204c, 206a, 206b, 206c and the hierarchy of answers 212, 214a, 214b, 214c, 216a, 216b, 216c that may include the optimal answer 202 to a user.

It may be appreciated that FIGS. 2A, 2B, and 3 provide only illustrations of one implementation and does not imply any limitations with regard to how different embodiments may be implemented. Many modifications to the depicted environments may be made based on design and implementation requirements.

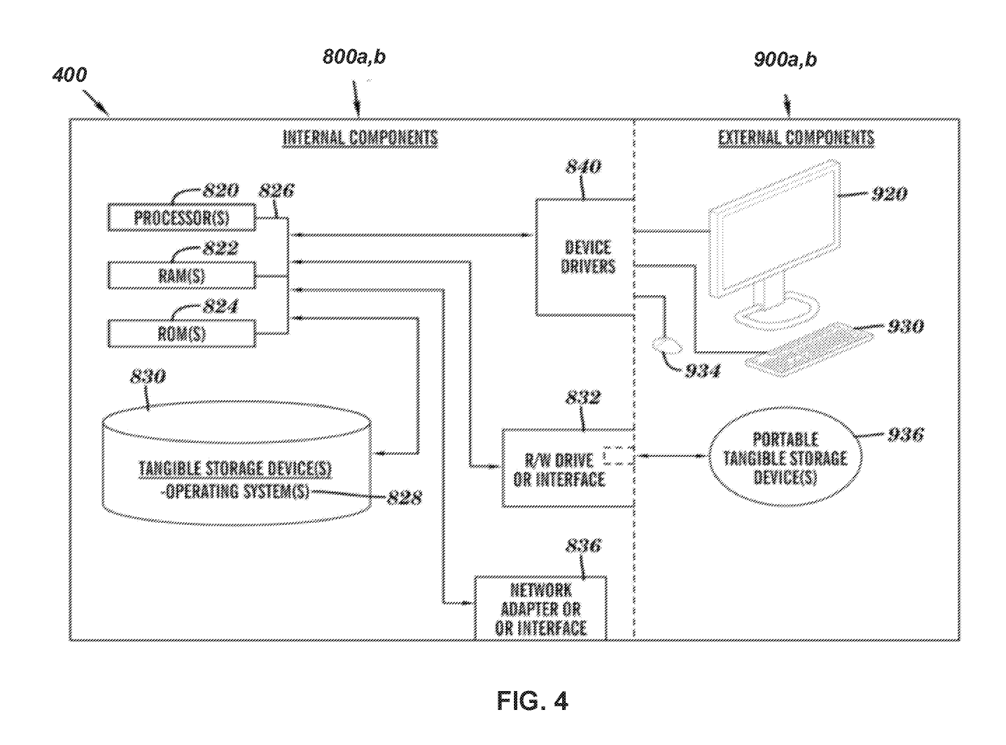

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 4. Each of the sets of internal components 800 a, b includes one or more processors 820, one or more computer-readable RAMs 822, and one or more computer-readable ROMs 824 on one or more buses 826, and one or more operating systems 828 and one or more computer-readable tangible storage devices 830. The one or more operating systems 828, the software program 114 (FIG. 1) and the hierarchical question answering program 108A (FIG. 1) in client computer 102 (FIG. 1), and the hierarchical question answering program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as a hierarchical question answering program 108A and 108B (FIG. 1), can be stored on one or more of the respective portable computer-readable tangible storage devices 936, read via the respective R/W drive or interface 832, and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The hierarchical question answering program 108A (FIG. 1) and software program 114 (FIG. 1) in client computer 102 (FIG. 1), and the hierarchical question answering program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the hierarchical question answering program 108A (FIG. 1) and software program 114 (FIG. 1) in client computer 102 (FIG. 1) and the hierarchical question answering program 108B (FIG. 1) in network server computer 112 (FIG. 1) are loaded into the respective hard drive 830. The network may comprise copper wires, optical fibers, wireless transmission, routers, firewalls, switches, gateway computers, and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930, and computer mouse 934. The device drivers 840, R/W drive or interface 832, and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

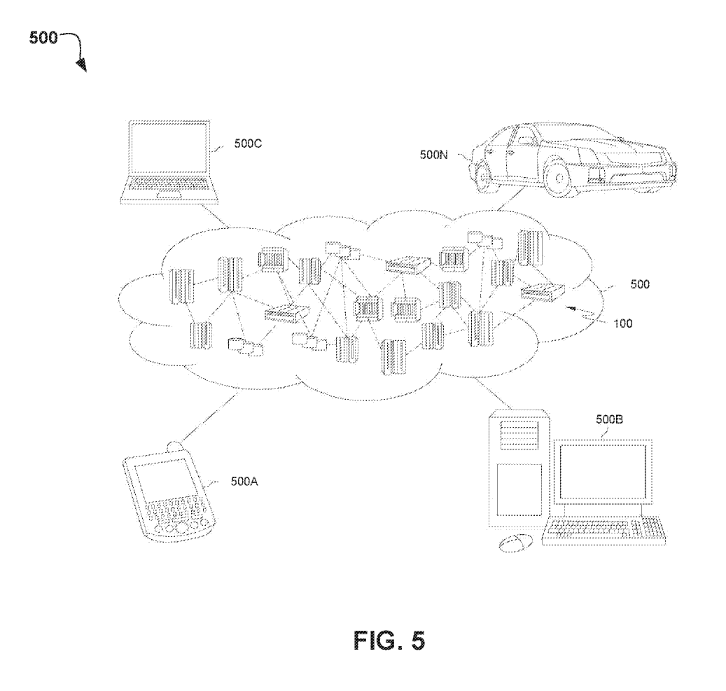

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

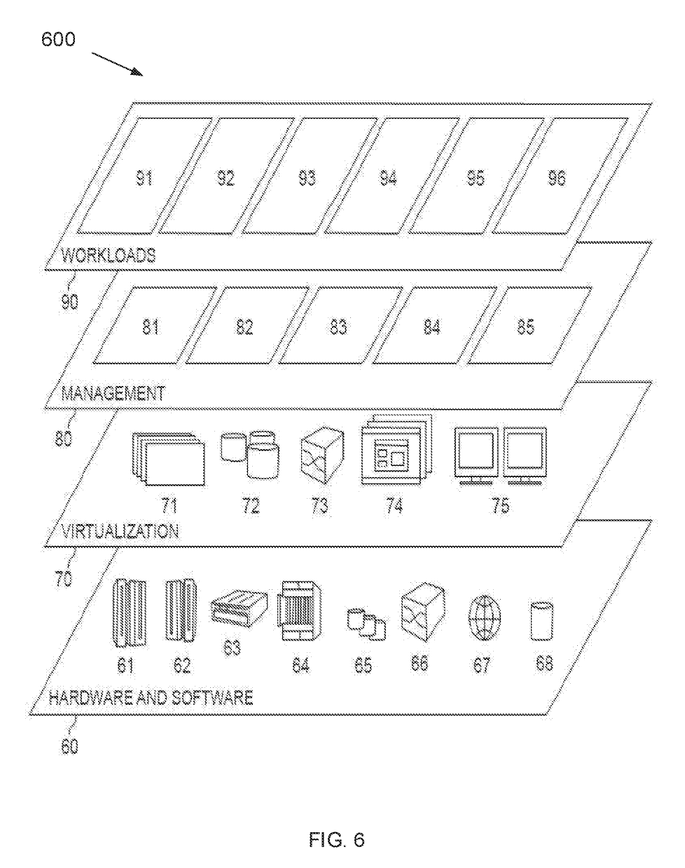

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and hierarchical question answering 96. A hierarchical question answering program 108A, 108B (FIG. 1) may be offered “as a service in the cloud” (i.e., Software as a Service (SaaS)) for applications running on computing devices 102 (FIG. 1) and may provide a hierarchical question answering system for presenting structured answers to a query.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a hierarchical question answering system for presenting structured answers to a query, the method comprising:
receiving at least one query for a question answering system;
generating a first set of queries based on the received at least one query;
generating a second set of queries based on the generated first set of queries;
clustering the received at least one query, the generated first set of queries, and the generated second set of queries to form a hierarchy of queries;
processing the hierarchy of queries via the question answering system to generate a plurality of answers associated with the hierarchy of queries;
clustering the generated plurality of answers to form a hierarchy of answers that match the hierarchy of queries;
ranking the hierarchy of answers associated with the hierarchy of queries for the received at least one query;
aggregating one or more answers from the hierarchy of answers to generate an optimal answer to the received at least one query;
presenting the hierarchy of queries, the hierarchy of answers, and the optimal answer to a user.

2. The method of claim 1, wherein the first set of queries are generated by syntactically paraphrasing the received at least one query.

3. The method of claim 1, wherein the second set of queries are generated by syntactically paraphrasing the first of queries.

4. The method of claim 1, wherein processing the hierarchy of queries via the question answering system to generate the plurality of answers further comprises:
receiving a plurality of references associated with the plurality of answers.

5. The method of claim 1, wherein ranking the hierarchy of answers associated with the hierarchy of queries for the received at least one query further comprises:
using a forest tree statistical model to rank the hierarchy of answers based on a confidence score.

6. The method of claim 5, wherein aggregating the one or more answers from the hierarchy of answers to generate the optimal answer to the received at least one query further comprises:
selecting the one or more answers based on the confidence score to generate the optimal answer to the received at least one query.

7. The method of claim 6, wherein aggregating the one or more answers from the hierarchy of answers to generate the optimal answer to the received at least one query further comprises:
selecting one or more sentences associated with the one or more answers based on the confidence score to generate the optimal answer to the received at least one query.

8. A computer system for providing a hierarchical question answering system for presenting structured answers to a query, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving at least one query for a question answering system;
generating a first set of queries based on the received at least one query;
generating a second set of queries based on the generated first set of queries;
clustering the received at least one query, the generated first set of queries, and the generated second set of queries to form a hierarchy of queries;
processing the hierarchy of queries via the question answering system to generate a plurality of answers associated with the hierarchy of queries;
clustering the generated plurality of answers to form a hierarchy of answers that match the hierarchy of queries;
ranking the hierarchy of answers associated with the hierarchy of queries for the received at least one query;
aggregating one or more answers from the hierarchy of answers to generate an optimal answer to the received at least one query;
presenting the hierarchy of queries, the hierarchy of answers, and the optimal answer to a user.

9. The computer system of claim 8, wherein the first set of queries are generated by syntactically paraphrasing the received at least one query.

10. The computer system of claim 8, wherein the second set of queries are generated by syntactically paraphrasing the first of queries.

11. The computer system of claim 8, wherein processing the hierarchy of queries via the question answering system to generate the plurality of answers further comprises:
receiving a plurality of references associated with the plurality of answers.

12. The computer system of claim 8, wherein ranking the hierarchy of answers associated with the hierarchy of queries for the received at least one query further comprises:
using a forest tree statistical model to rank the hierarchy of answers based on a confidence score.

13. The computer system of claim 12, wherein aggregating the one or more answers from the hierarchy of answers to generate the optimal answer to the received at least one query further comprises:
selecting the one or more answers based on the confidence score to generate the optimal answer to the received at least one query.

14. The computer system of claim 13, wherein aggregating the one or more answers from the hierarchy of answers to generate the optimal answer to the received at least one query further comprises:
selecting one or more sentences associated with the one or more answers based on the confidence score to generate the optimal answer to the received at least one query.

15. A computer program product for providing a hierarchical question answering system for presenting structured answers to a query, comprising:
one or more computer-readable storage devices and program instructions stored on at least one of the one or more tangible storage devices, the program instructions executable by a processor, the program instructions comprising:
program instructions to receive at least one query for a question answering system;
program instructions to generate a first set of queries based on the received at least one query;
program instructions to generate a second set of queries based on the generated first set of queries;
program instructions to cluster the received at least one query, the generated first set of queries, and the generated second set of queries to form a hierarchy of queries;
program instructions to process the hierarchy of queries via the question answering system to generate a plurality of answers associated with the hierarchy of queries;
program instructions to cluster the generated plurality of answers to form a hierarchy of answers that match the hierarchy of queries;
program instructions to rank the hierarchy of answers associated with the hierarchy of queries for the received at least one query;
program instructions to aggregate one or more answers from the hierarchy of answers to generate an optimal answer to the received at least one query;
program instructions to present the hierarchy of queries, the hierarchy of answers, and the optimal answer to a user.

16. The computer program product of claim 15, wherein the first set of queries are generated by syntactically paraphrasing the received at least one query.

17. The computer program product of claim 15, wherein the second set of queries are generated by syntactically paraphrasing the first of queries.

18. The computer program product of claim 15, wherein the program instructions to rank the hierarchy of answers associated with the hierarchy of queries for the received at least one query further comprises:
program instructions to use a forest tree statistical model to rank the hierarchy of answers based on a confidence score.

19. The computer program product of claim 18, wherein the program instructions to aggregate the one or more answers from the hierarchy of answers to generate the optimal answer to the received at least one query further comprises:
program instructions to select the one or more answers based on the confidence score to generate the optimal answer to the received at least one query.

20. The computer program product of claim 19, wherein the program instructions to aggregate the one or more answers from the hierarchy of answers to generate the optimal answer to the received at least one query further comprises:
program instruction to select one or more sentences associated with the one or more answers based on the confidence score to generate the optimal answer to the received at least one query.
